(19) United States
(12) Patent Application Publication
(10) Pub. No.: US 2020/0386302 A1
(43) Pub. Date: Dec. 10, 2020

(54) TENSIONING ROLLER AND DEVICE FOR ADJUSTING A TENSIONING ARRANGEMENT

(71) Applicant: Muhr und Bender KG, Attendom (DE)

(72) Inventors: Andre Goldfisch, Weitefeld (DE); Florian Stadermann, Attendorn (DE); Joachim Jud, Daaden (DE)

(21) Appl. No.: 16/888,924

(22) Filed: Jun. 1, 2020

(30) Foreign Application Priority Data
Jun. 7, 2019 (DE) 10 2019 115 628.9

(51) Int. Cl. F16H 7/12; F16H 7/02

(52) U.S. Cl. CPC F16H 7/1281; F16H 2007/0842; F16H 7/02

(57) ABSTRACT

A tensioning arrangement for a traction drive comprises a base member; at least one tensioning arm, which is pivotably mounted relative to the base member about a pivot axis; a tensioning roller that is connected to a carrier element of the at least one tensioning arm by a bearing so as to be rotatable about an axis of rotation; and an adjustment mechanism configured to pivot the bearing relative to the carrier element within a pivot range and to fasten the bearing in a pivot position within the pivot range. A corresponding device can be provided for adjusting the tensioning arrangement.

### CROSS-REFERENCE TO RELATED APPLICATIONS

This application claims priority to German Application No. DE 10 2019 115 628.9, filed on Jun. 7, 2019, which application is hereby incorporated herein by reference in its entirety.

### BACKGROUND

A traction drive usually comprises an endless traction means and at least two drive pulleys, one of which can act as the drive and one as the output of the traction drive. Such traction drives are used, for example, on internal combustion engines of a motor vehicle to drive auxiliary units, a first drive pulley being located on the crankshaft of the internal combustion engine and driving the traction means. Other drive pulleys are assigned to the auxiliary units, such as water pump, alternator or air conditioning compressor, and are rotatingly driven by the traction drive. In conventional traction drives, the auxiliary units are designed as consumers, i.e. they are driven by the drive pulley of the crankshaft via the traction means. In this case, an undriven portion (slack side) of the traction means is formed between the crankshaft and the unit adjoining the crankshaft in circumferential direction of the traction means, said adjoining unit typically being a generator. To ensure a sufficient wrap of the traction means around the drive pulley, the traction means is pretensioned by a tensioning roller of the tensioning arrangement.

Depending on the arrangement of the auxiliary units present in such a traction drive (generator, water pump, air-conditioning compressor), a traction drive can react more or less sensitively to a defective position on a drive pulley. This applies in particular to the drive pulley in the run before entering a generator. This can lead to an undesired axial running behaviour of the traction means, which can have negative effects such as wear of the traction means or noise.

From DE 10 2011 088 213 A1 a tensioning arrangement for a traction drive of a power unit of an internal combustion engine is known. The tensioning arrangement comprises several pulleys drivingly connected via a traction means, one of which being connected to an auxiliary unit of the internal combustion engine. Two tensioning elements are arranged on both sides of the pulley connected to the unit, which are mounted on a common lever. The tensioning elements are each pretensioned against the traction means via the lever by means of a tensioning unit. In order to prevent excessive stressing of the traction means by axial movement, which can occur due to misalignment between the tensioning element and the pulley, a roller of the tensioning element guiding the traction means is designed spherical and mounted in the lever so that it can be tilted about a vertical axis or moved axially.

From WO 201 8/1 781 43 A1 a tensioning device for a traction drive is known. The tensioning device comprises a base member, a tensioning arm with a bearing carrier and a tensioning roller, which is mounted so as to be pivotable relative to the base member, and spring means for loading the tensioning arm. An adjusting device is provided for adjusting a spring support relative to the bearing carrier of the tensioning roller.

From DE 10 2015 111 809 A1 a tensioning device for a traction means is known, which comprises a receiving housing, a roller carrier with a tensioning roller, a bearing arrangement with which the roller carrier is mounted in the receiving housing so as to be rotatable about an axis of rotation, and a helical tension spring which is supported on the receiving housing and the roller carrier in the circumferential direction and in the axial direction respectively.

### SUMMARY

The present disclosure relates to a tensioning arrangement for a traction drive and to a device for adjusting a tensioning arrangement. The present disclosure describes a tensioning arrangement which allows a traction means to run well on the tensioner roller and with a long service life. The present disclosure further describes a corresponding adjusting device with which such a tensioning arrangement can be adjusted.

A tensioning arrangement for a traction drive comprises: a base member; at least one tensioning arm, which is pivotally mounted relative to the base member about a pivot axis; a tensioning roller, which is rotatably connected to a carrier element of the at least one tensioning arm by a bearing about an axis of rotation; and an adjustment mechanism configured to pivot the bearing relative to the carrier element in a pivoting range and to fix the bearing in a pivoted position within the pivoting range.

An advantage of the tensioning arrangement is that the bearing and, respectively, the tensioning roller rotatably mounted therewith can be adjusted relative to the carrier element and, respectively, the base member of the tensioning arrangement by means of the adjustment mechanism. Thus, a defined misalignment of the tensioning roller relative to the roller carrier and the base member, respectively, can be achieved in a simple and cost-effective manner, wherein the misalignment can also be zero. The defined alignment, respectively the defined misalignment, can be maintained within very narrow tolerances, so that a high positional accuracy of the tensioning roller relative to the traction means is achieved during operation of the tensioning arrangement. The defined alignment, respectively the defined misalignment, can also include a pre-tilting within the narrow tolerances.

The tensioning arrangement is used to tension a traction means of a traction drive; it can also be referred to as tensioner for short. The traction drive is designed to transmit torque between two or more shafts by means of the endless traction means. In particular, the traction drive can be designed as a belt drive, toothed belt drive or chain drive. Accordingly, the tensioning arrangement can be designed in the form of a belt tensioning arrangement or chain tensioning arrangement. The tensioning arrangement can also be referred to as tensioning assembly or tensioning device.

With the aid of the adjustment mechanism, the tensioning roller can be adjusted and fixed relative to the carrier element within a defined adjustment range. In particular, it is provided that the tensioning roller bearing is pivotable with its axis of rotation relative to a carrier axis (A12) of the carrier element within a limited pivoting range. The pivoting range or pivoting angle (a) by which the bearing of the tensioning roller, respectively its axis of rotation (A5), is pivotable relative to the carrier element, respectively a carrier axis (A12), for example amounts up to a maximum of ±1° (α=±) 1°. The carrier axis (A12) extends in particular parallel to the pivot axis (A4, A6) of the tensioning arm through the bearing center (C) of the tensioning roller bearing. By limiting the pivot angle range (a), an incorrect adjustment or failure when the adjustment mechanism is released can be prevented.

The adjustment mechanism can be designed in particular in such a way that the tensioning roller is pivotable at least in a pivoting plane (Ea) which, in axial view of the carrier axis (A12), lies within an angular range (β) of up to ±30° around the carrier axis (A12) relative to a tangent plane (T). The tangent plane (T) can be defined as a plane perpendicular to the radius (R) extending from the pivot axis (A4) to the carrier axis (A12) or to the bearing center (C). It goes without saying that the adjustment mechanism can also be designed in such a way that the axis of rotation (A5) relative to the carrier axis (A12)—in axial view of the carrier axis (A12)—can also be pivoted within larger angular ranges (6), in particular also in any pivoting direction around the carrier axis (A12), that is over 360° around the carrier axis.

In an example, the adjusting mechanism can comprise a bearing receptacle in which the bearing is received, a supporting element against which the bearing receptacle is axially supported, and a clamping element for clamping the bearing receptacle against the supporting element. When the clamping element is not tensioned, the bearing receptacle is pivotable relative to the supporting element so that the bearing and the tensioning roller, respectively, can be set to the desired position relative to the supporting element. Subsequent tensioning by means of the clamping element fixes the bearing receptacle and the tensioning roller mounted therein in the desired position relative to the supporting element and the roller carrier, respectively.

On the side facing the carrier element, the bearing receptacle can have a contact face which is in contact with a supporting face of the supporting element. The contact face of the bearing receptacle and/or the supporting face of the supporting element are designed in such a way that the bearing receptacle can be pivoted and brought into contact in various positions relative to the supporting element. In particular, at least one of the contact face and the supporting face can be spherical, with, for example, both surfaces being spherical. The supporting face can be concave, while the contact face can be convex.

On the side facing away from the carrier element, the bearing receptacle can have a pressure face that can be brought into contact with and/or acted upon by a clamping face of the clamping element. Here, too, the pressure face of the bearing receptacle and/or the clamping face of the clamping element is designed in such a way that the bearing receptacle can be pivoted in various positions relative to the clamping element and can be loaded by same. In particular, at least one of the pressure face and the clamping face can be spherical, whereby both surfaces can be spherical.

In an example, the bearing can be pivoted relative to the carrier element about a pivot point that lies within the axial extension of the bearing. In this case the pressure face can be convex and the contact face can be concave. Furthermore, a radius of the spherical face (pressure face and/or contact face) can be smaller than a greatest outer radius of the tensioning roller, in particular smaller than a greatest outer radius of the bearing. In an example, the surface pairings are designed in such a way that overall a spherical structure of the bearing receptacle is obtained, wherein the centre of rotation resulting from the surface pairings can be located in the bearing centre plane.

In an example, the bearing can be pivoted relative to the carrier element about a pivot point that lies outside the axial extension of the bearing, in particular on a side opposite to the base member with respect to a bearing centre plane. In this case the pressure face can be concave and the contact face can be convex. Furthermore, a radius of the spherical face (pressure face and/or contact face) can be larger than a greatest outer radius of the bearing, in particular larger than a greatest outer radius of the tensioning roller. In an example, the surface pairings are designed in such a way that overall a double-spherical structure of the bearing receptacle is obtained, wherein the pivot point resulting from the surface pairings can be located with an axial offset to the tensioning roller.

In an example, the bearing receptacle can have a two-part design, with a first bearing receiving part that receives the bearing at a first axial end and a second bearing receiving part that receives the bearing at a second axial end. The first and the second bearing receiving part can be pivoted to a limited extent relative to the supporting element, and clamping element respectively, and can be axially clamped against each other in the desired pivot position by the clamping element. The bearing receptacle receives and holds the bearing and can thus also be referred to as bearing retainer, bearing holder or bearing seat.

The bearing receptacle can have a central bore through which the clamping element extends, with the clamping element having radial clearance relative to a bore wall. In a two-part design of the bearing receptacle, for example, both bearing receiving parts have a through bore through which the clamping element is inserted and clamped to the carrier element.

In particular, the clamping element is releasably clamped to the carrier element, for example by a bolted connection. For this purpose, one of the clamping element and the carrier element can comprise a bolt or screw with an outer thread, and the other of the clamping element and the carrier element can comprise a nut with an inner thread matching the bolt thread.

The tensioning arrangement can be designed as a single-arm or two-arm tensioning device. In a single-arm tensioner, exactly one tensioning arm is provided, which by spring means is resiliently supported in the circumferential direction against the base member. In this embodiment, one spring end is supported on the tensioning arm and the other spring end is supported on the base member in the circumferential direction, so that the tensioning arm can exert a resilient pretensioning force at a portion on the traction means when installed.

A two-arm tensioner has two tensioning arms, namely a first tensioning arm with a first tensioning roller and a second tensioning arm with a second tensioning roller, with the two tensioning arms being supported against each other in the circumferential direction by spring means. The first tensioning arm loads the traction means by the first tensioning roller. The second tensioning arm loads the traction means by the second tensioning roller. The two tensioning arms can be supported against each other and/or against the base member so as to be pivotable about their own or a common pivot axis. In this embodiment with two tensioning arms, a first spring end is supported in the circumferential direction on the first tensioning arm and a second spring end is supported on the second tensioning arm in the circumferential direction, so that the two tensioning arms are supported resiliently relative to each other in the circumferential direction via the spring means.

Two-arm tensioners are used in belt drives in which a starter generator is comprised in the belt drive as an auxiliary unit, i.e. an electric motor that can be operated as a starter (starter) or alternator (generator) depending on the operating mode. In normal or engine operation, the belt pulley on the crankshaft is the driving pulley, while the starter generator is driven like the other auxiliary units. In starting or starter mode, the starter generator drives the crankshaft via the associated pulley to start the combustion engine. In such belt drives with a starter generator as an auxiliary unit, between engine operation on the one hand and starter operation on the other hand, there is a change between the tight side and the slack side of the belt with respect to both sides of the pulley of the starter generator. It is therefore necessary to provide spring-loaded tensioning rollers for both of the said sides of the belt and thus two tensioning arms, one of which acts on the slack side under spring force, while the other is forced back by the tensioned side of the belt.

The present disclosure describes a device for adjusting a tensioning arrangement, which can be designed according to one or more of the above-mentioned embodiments, comprising: a base plate, a holding device for fixing the tensioning arrangement to the base plate, and an alignment element, which is connected to the base plate and has at least one alignment face against which the tensioning roller can be brought into contact in the tensioned state of the tensioning arrangement, such as a belt tensioner.

With this device, the tensioning roller can be easily adjusted to the desired position relative to the carrier element and the base member of the tensioning arrangement, respectively, and fixed in this position. At the beginning, the alignment element of the adjusting device can be adjusted once to the position required for the desired pivot position of the tensioning roller. By placing the tensioning arrangement on the holding device and making the tensioning roller contact against the alignment face under spring preload, the tensioning roller is pivoted into the desired position. By subsequently tensioning the tensioning roller on the carrier element, the arrangement is fixed in this position.

In an example, the alignment element has at least two alignment faces offset to each other in the circumferential direction of the tensioning roller. In this way a secure support in a plane parallel to the bearing axis is achieved. Alternatively or additionally, the alignment element can have at least two alignment faces that are offset to each other in the axial direction of the tensioning roller. In this way, a secure support in a plane parallel to the bearing axis is achieved.

### BRIEF DESCRIPTION OF THE DRAWINGS

FIG. 1A an example tensioning arrangement in a perspective view;

FIG. 1Ba roller unit of the tensioning arrangement of FIG. 1A in a longitudinal section in a first adjustment position of the roller axis;

FIG. 1Ca roller unit of the tensioning arrangement of FIG. 1A in a longitudinal section in a second adjustment position of the roller axis;

FIG. 2 a roller unit for a tensioning arrangement in a modified example in a longitudinal section;

FIG. 3 a roller unit for a tensioning arrangement in a further example in a longitudinal section;

FIG. 4a belt drive with a tensioning arrangement;

FIG. 5Aa tensioning arrangement in a second example in a perspective view;

FIG. 5Ba roller unit of the tensioning arrangement of FIG. 5A in a first adjustment position of the roller axis;

FIG. 5Ca roller unit of the tensioning arrangement of FIG. 5A in a second adjustment position of the roller axis;

FIG. 6 schematically a tensioning arrangement in axial view with special representation of the geometries;

FIG. 7 an adjusting device for adjusting a tensioning arrangement according to any of FIGS. 1 to 4, in a first example;

FIG. 8 an adjusting device for adjusting a tensioning arrangement according to any one of FIGS. 1 to 4, in a second embodiment; and

FIG. 9 an adjusting device for adjusting a tensioning arrangement according to FIG. 5.

### DETAILED DESCRIPTION

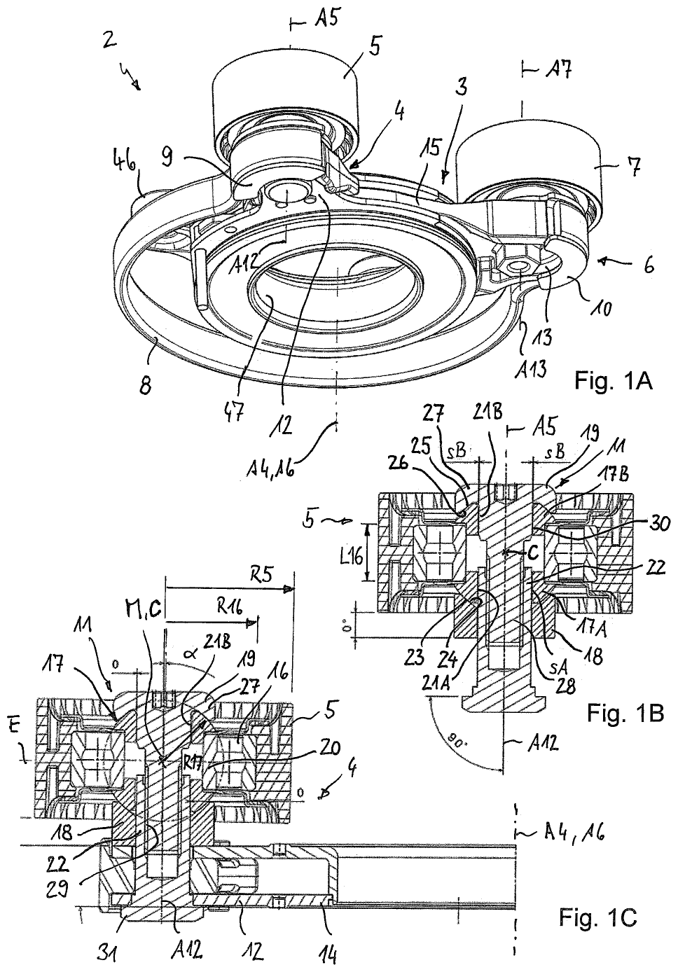

FIGS. 1A to 10 (collectively, “FIG. 1”), described together in the following, show a tensioning arrangement 2 in a first embodiment. The tensioning arrangement 2 comprises a base member 3, a first tensioning arm 4 with a first tensioning roller 5, a second tensioning arm 6 with a second tensioning roller 7, and a spring 8, via which the two tensioning arms 4, 6 are resiliently supported against each other in the circumferential direction. The spring 8 extends between a first spring support 9 of the first tensioning arm 4 and a second spring support 10 of the second tensioning arm 6 in the circumferential direction around an axis A of the tensioning arrangement.

The base member 3 can be attached to a stationary component such as an auxiliary unit. In principle, the auxiliary unit can be any machine which is part of the belt drive, i.e. in particular any of the auxiliary units driven by the main engine of the motor vehicle, such as the generator, water pump or the like. For connection to the stationary component, the base member 3 has fastening elements 46, which in particular can be configured as radially outwardly projecting flange projections with holes, through which screws for fastening to the stationary component may be inserted.

The two tensioning arms 4, 6 of the tensioning arrangement 2 are mounted so as to be rotatable about a pivot axis A4, A6 relative to each other, respectively relative to the base member 3 by means of appropriate bearing means. The base member 3, the first tensioning arm 4 and/or the second tensioning arm 6 can be manufactured as steel components, which in particular may be formed from sheet metal, or as light metal components, in particular from an aluminium casting alloy, or from plastic, in particular a fibre-reinforced plastic.

The first tensioning arm 4 is pivotably supported around a first pivot axis A4 by a first bearing. The second tensioning arm 6 is pivotably supported about a second pivot axis A6 by a second bearing. The two bearings are arranged coaxially, i.e. the two pivot axes A4 and A6 coincide. However, for certain embodiments it is also possible that the two pivot axes can be arranged parallel or eccentrically to each other.

The spring 8 extending circumferentially around the pivot axes A4, A6 counteracts a relative pivot movement of the two tensioning arms 4, 6. The two tensioning arms 4, 6 can be rotated relative to each other only to a limited extent due to the interposed spring 8 and, together with the spring 8, can rotate freely about the axes A4, A6 relative to the base member 3, i.e. by 360° and more. The pivot axes A4, A6 are arranged within the opening 47 of the base member 3 when the tensioning arrangement 2 is mounted.

The tensioning arms 4, 6 each have a carrier element 12, 13 which projects radially outwardly from an annular portion 14, 15 of the respective tensioning arm 4, 6. An associated tensioning roller 5, 7 is mounted to each carrier element 12, 13. The tensioning rollers 5, 7 are rotatably supported by respective bearings 16 about axes of rotation A5, A7 which are at least substantially parallel to the pivot axes A4, A6.

For example, at least one of the two tensioning arms 4, 6 is provided with an adjusting mechanism 11 in order to pivot the tensioning roller bearing 16 relative to the associated carrier element 12, 13 in a pivoting range and to fasten it in a pivoting position within the pivoting range. For this purpose, the tensioning roller bearing 16 can be pivoted with its axis of rotation A5, A7 relative to a carrier axis A12, A13 of the carrier element 12, 13 within a limited pivoting range a. The pivot range a is, for example, up to a maximum of ±1° (α±1°) about the axis A12, A13 of the carrier element, respectively about the pivot axis A4, A6 of the tensioning arm.

The adjusting mechanism 11 has a bearing receptacle 17 for the bearing 16, a supporting element 18 for supporting the bearing receptacle 17 in the direction of the carrier element 12, 13, and a tensioning element 19 for tensioning the bearing receptacle 17 against the supporting element 18, The bearing receptacle 17 can be pivoted and/or rotated relative to the supporting element 18 when the tensioning element 19 is released or not tensioned, so that the bearing 16 and the tensioning roller 5, 7 connected thereto can be adjusted to the desired position relative to the supporting element 18. By subsequently tensioning the arrangement by means of the tensioning element 19, the bearing receptacle 17 and the tensioning roller 5, 7 rotatably supported therein is fixed in the desired position relative to the supporting element 18 and the carrier element 12, 13, respectively.

In an example, the bearing receptacle 17 is designed in two parts and comprises a first bearing receiving part 17A, which receives a bearing inner ring 20 of the bearing 16 at a first axial end, and a second bearing receiving part 17B, which receives the bearing inner ring 20 at a second axial end. The first and second bearing receiving parts can also be referred to as bearing seat parts. In the unclamped state, the two bearing receiving parts 17A, 17B can be pivoted relative to the supporting element 18 and clamping element 19 respectively. In the desired pivot position of the tensioning roller 5, 7 relative to the respective carrier element 12, 13, the tensioning element 19 is braced against the supporting element 18 with the bearing receptacle 17 being interposed therebetween, so that the alignment of the tensioning roller is fixed. This adjustment position is maintained when operating the tensioning arrangement in a belt drive, so that the belt rests evenly on the adjusted tensioning roller and is guided securely.

The bearing receptacle 17 and the two receiving parts 17A, 17B have a central bore 21A, 21B, through which the clamping element 19 extends. As can be seen in particular in FIG. 1B, which shows the bearing 16 in coaxial arrangement to the carrier axis A12, a radial clearance sA is provided between the bore 21A of the bearing receiving part 17A and a part 22 arranged radially inward thereto. Alternatively or in addition, a radial clearance sB is provided all around between the clamping element 19 and the bore 21B of the receiving part 17B. The radial clearance sA, sB can be between 0.1 mm and 0.3 mm all around. The radial clearance sA, sB allows the respective receiving part 17A, 17B to be pivoted to a limited extent relative to the clamping element 19 or part 22. FIG. 10 shows a second clamping position in which the bearing retainer 17 is pivoted relative to the carrier axis A12 and/or a line parallel to the pivot axis A4 by a pivot angle α. The pivot angle α is, for example, less than or equal to 1° relative to the axis A12, which in particular is parallel to the pivot axis A4. When the bearing receptacle 17 is pivoted further, it comes into contact with the clamping element 19 and/or the sleeve portion 22, so that a pivot stop is formed in this way.

On the side facing the carrier element 12, the bearing receptacle 17, more particularly the bearing receiving part 17A has a contact face 23 which is in contact with a support face 24 of the supporting element 18. The pair of faces formed by the contact face 23 and the supporting face 24 is designed in such a way that the bearing receiving part 17A can be pivoted into various positions relative to the supporting element 18 and brought into contact with same. For this purpose, the contact face 23 is in particular spherical or convex, and the supporting face 24 is in particular hollow-spherical or concave.

The bearing receiving part 17B on the side facing away from the carrier element 12 has a pressure face 25 which can be brought into contact with a clamping face 26 of the clamping element 19 and can be loaded by same. Here, too, the pair of faces formed by the pressure face 25 and the clamping face 26 is designed in such a way that the bearing seat 17B can be pivoted in various positions relative to the clamping element 19 and can be loaded by same. For this purpose, the pressure face 25 is designed in particular to be spherical or convex, and the clamping face 26 is designed in particular to be hollow-spherical or concave.

All in all, the spherical contact face 23 of the lower bearing receiving part 17A and the spherical pressure face 25 of the upper bearing receiving part 17B result in an overall spherical shape of the bearing retainer 17, so that a kind of ball joint is formed in cooperation with the supporting element 18 and the clamping element 19.

The pairs of faces 23, 24; 25, 26 in the present embodiment are designed in such a way that the bearing receptacle 17 can be pivoted about a pivot point M relative to part 22 and/or the carrier element 12. The pivot point M lies within the axial extension of the bearing 16, in particular in the bearing centre plane E. The radius R17 of the spherical outer faces 23, 25 of the bearing receptacle 17 and/or the spherical inner faces 24, 26 is smaller than a greatest outer radius R5 of the tensioning roller 5, in particular smaller than a maximum outer radius R16 of the bearing 16.

The clamping element 19 is designed in the form of a clamping screw or bolt which can be detachably clamped to part 22 supported against the carrier portion 12. Accordingly, the clamping element 19 has a head portion 27 for supporting against the bearing receptacle 17 and a threaded portion 28 for screwing to part 22. Part 22 has a sleeve portion with an internal thread 29 into which the clamping element is screwed with its external thread. The head portion 27 of the clamping element 19 comprises on its inside the clamping face 26 and on its outside an engagement contour for introducing a torque by means of a suitable tool. Furthermore, the clamping element 19 comprises a cylindrical portion 30 adjoining the head portion 27, which is positioned with radial clearance in the through bore 21B of the bearing receiving part 17B. The part 22 is axially supported by a head portion 31 against the carrier portion 12 of the tensioning arm. The supporting element 18 is annularly formed and is arranged coaxially around part 22. The supporting element 18 is axially braced by the clamping element 19 and part 22 between the bearing receptacle 17 and the carrier portion 12 of the tensioning arm.

Depending on the application and use of tensioner arrangement 2, only the first tensioning roller 5, or only the second tensioning roller 6, or both tensioning rollers 5, 6 can be equipped with an adjustment mechanism 11 as shown in FIGS. 1B and 10.

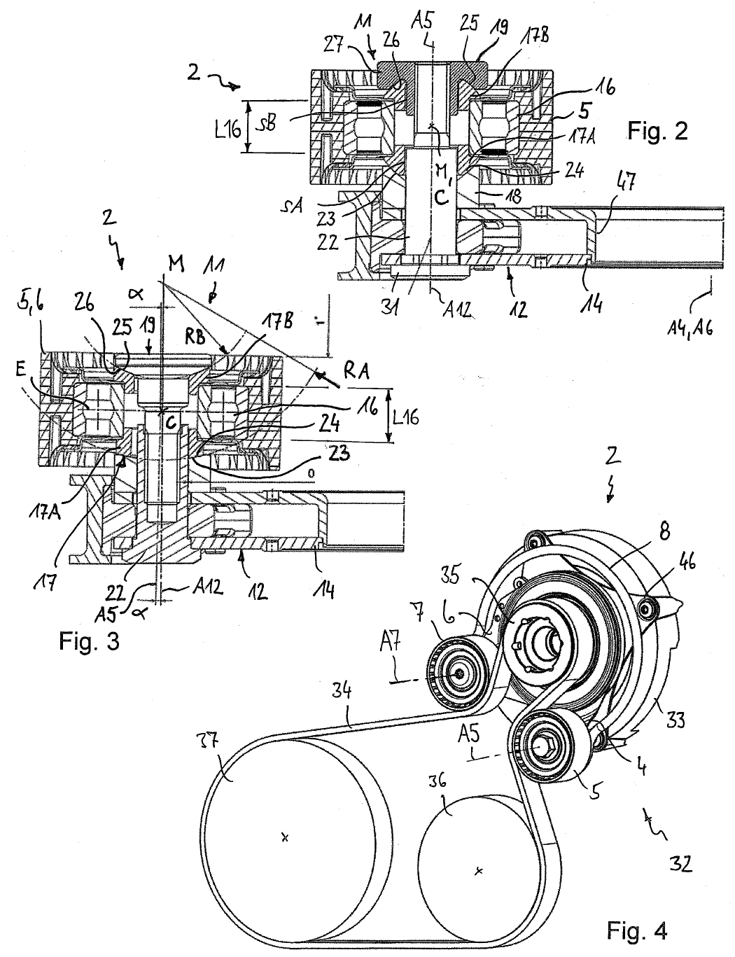

FIG. 2 shows an inventive tensioning arrangement 2 in a modified embodiment. The present tensioning arrangement 2 according to FIG. 2 largely corresponds to the embodiment according to FIG. 1, so that reference is made to the above description of FIG. 1 with regard to the common features. The same or modified details are marked with the same reference signs as in FIGS. 1A to 1C.

The only difference lies in the design of clamping element 19 and part 22, which are cinematically reversed in this case. The element 22 is designed in the form of a clamping bolt which is inserted through the tensioning arm 12 and is axially supported by a head portion 31. Accordingly, the clamping element 19 is designed in the form of a clamping nut which engages with an inner thread in an outer thread of the clamping bolt 22. The head portion 27 of the clamping nut 19 comprises the internal clamping face 26 for acting on the bearing receiving part 17B. On the outside, the clamping nut can have an engagement contour for introducing a torque by means of a suitable tool. As with the above-described embodiment, only one tensioning roller 5, 6, or both tensioning rollers 5, 6 can be equipped with the described adjustment mechanism 11 as shown in FIG. 2. A further modified embodiment is also possible, in which one tensioning arm is equipped with the adjustment mechanism as shown in FIG. 1 and the other tensioning arm with the adjustment mechanism as shown in FIG. 2.

FIG. 3 shows a tensioning arrangement 2 in a further modified embodiment. The clamping device 2 according to FIG. 3 widely corresponds to the embodiment according to FIG. 1, so that with regard to the common features reference is made to the above description of FIG. 1. The same or modified details are marked with the same reference signs as in FIGA. 1A to 1C.

A special feature is the design of the adjusting mechanism 11, which in the embodiment according to FIG. 3 is designed in such a way that the tensioning rollers 5, 6 respectively the bearing 16 can be pivoted relative to the carrier element 12 about a pivot point M which is outside the axial extension of the bearing 16. It can be seen in FIG. 3 that the pivot point M is located on an opposite side to the carrier element 12 with respect to a bearing centre plane E. In this case, the pressure face 25 of the bearing carrier 17B is convex and the clamping face 26 is concave. Furthermore, the radius RB of the spherical faces 25, 26 is larger than a greatest outer radius of the bearing 16. The contact face 23 of the bearing carrier 17A is convex and the support face 24 of the supporting element 18 is concave, the radius RA of the spherical faces 23, 24 being larger than the radius RB of the spherical faces 25, 26, in particular larger than a greatest outer radius of the tensioning roller 5, 6. This results in a substantially double spherical structure of the bearing supports 17A, 17B. The present embodiment enables a particularly flat structure of the upper bearing receiving part 17B, so that the required axial installation space is small overall. In an example, the end face of the tensioning element 19 lies within the axial extension of the tensioning roller 5, 6.

FIG. 4 shows a tensioning arrangement 2 in an installed state in a belt drive 32. For this, the tensioning arrangement 2 is attached to a stationary component, in this case to an auxiliary unit 33, the belt 34 is placed around all drive pulleys 35, 36, 37 and the tensioning rollers 5, 7 are loaded under spring pre-tension against the belt 34. The auxiliary unit 33 can be an alternator, for example. The tensioning arrangement 2 is attached to the front of the auxiliary unit 33. This is done by means of the circumferentially distributed mounting flanges 46, into which bolts can be inserted and screwed to the housing of the auxiliary unit. The tensioning arrangement 2 is designed in such a way that—when mounted on the auxiliary unit 33—the pivot axes A4, A6 of the tensioning arms 4, 6 are arranged within the outer diameter of the drive pulley 35.

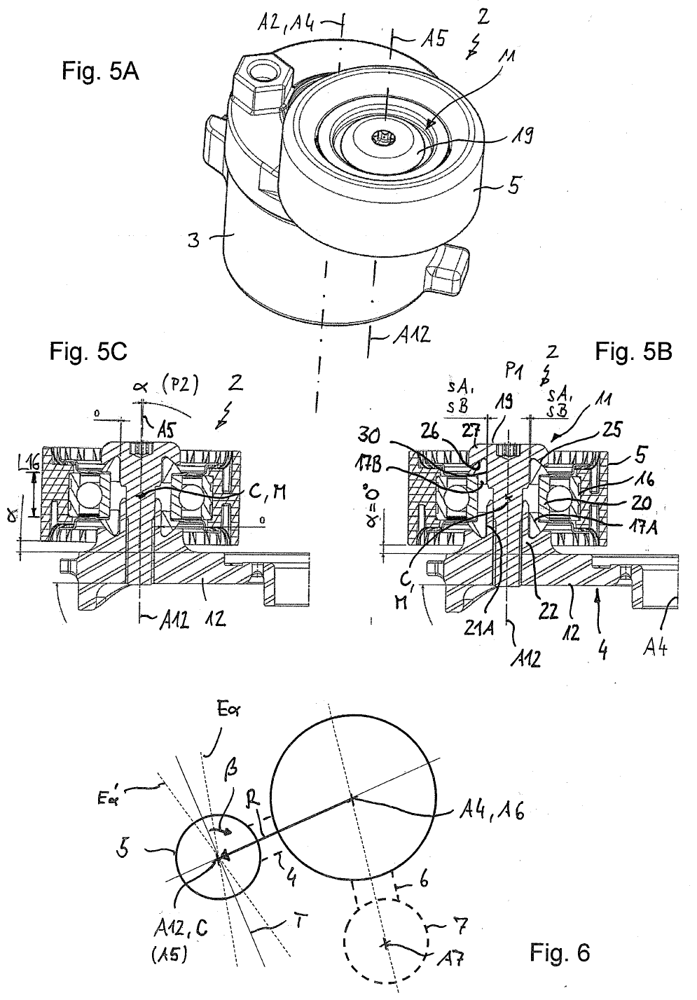

FIGS. 5A to 5C, jointly also referred to as FIG. 5, show a tensioning arrangement 2 in another example. The present tensioning arrangement 2 largely corresponds to the embodiment shown in FIGS. 1A to 10, the description of which is referred to in abbreviated form for common features. The same or modified details are marked with the same reference signs as in the above figures.

The tensioning arrangement 2 according to the present embodiment has only one single tensioning arm 4 with corresponding tensioning roller 5. The first spring support is assigned to the single tensioning arm 4, as in the above embodiments. The second spring support is assigned to the base member 3 and/or is formed on same. The spring is arranged within the base member 3 and is not visible.

Another difference is that part 22, with which the clamping element 19 is clamped, is designed in one piece with the carrier element 12. For this purpose, the carrier element 12 of the tensioning arm 4 has a bore with an internal thread, into which the clamping element 19, designed as a clamping screw, is screwed. The tensioning arm 4 and carrier portion 12 respectively is designed as a solid part, for example as a light metal casting.

FIG. 5B shows the bearing 16 in a first possible setting position P1 in a coaxial arrangement with respect to the carrier axis A12, with a radial clearance sA between the bore 21A of the bearing receiving part 17A and the sleeve portion 22 arranged radially inward thereto. Accordingly, a radial clearance sB is provided between the bore 21B of the bearing receiving part 17B and the radially inner cylinder portion 30. The radial clearance sA, sB can be between 0.1 mm and 0.3 mm on both sides. FIG. 5C shows a second clamping position P2 in which the bearing receptacle 17 is pivoted by a pivot angle α relative to the carrier axis A12, respectively a line parallel to the pivot axis A4. The pivot angle α is, for example, less than or equal to 1° relative to the axis A12 respectively A4. When the bearing receptacle 17 is pivoted further, it comes into contact with the clamping element 19 and/or the sleeve portion 22, so that a pivot stop is formed.

For all other details of design and operation, the tensioning arrangement 2 in FIGS. 5A to 5C corresponds to that in FIGS. 1A to 1C, to the description of which it is referred to in abbreviated form.

FIG. 6 schematically shows a tensioning arrangement 2, which can be designed as a two-arm tensioner according to FIGS. 1 to 4 or as a one-arm tensioner according to FIG. 5. One tensioning roller (5) is shown for a single-arm tensioner with a continuous line, and a second tensioning roller (7) for a two-arm tensioner with a dashed line. The geometric relationships are explained above only on the basis of tensioning arm 4, although it is understood that these can also apply alternatively or additionally to the second tensioning arm 6. The illustration according to FIG. 6 serves in particular to explain the geometric relationships and applies in particular to all of the embodiments described above. The same or corresponding details are marked with the same reference signs as in the above figures.

The tensioning roller 5 can be pivoted with its axis of rotation A5 relative to the carrier axis A12 of the carrier element 12, wherein the carrier axis A12 can be defined as parallel to the pivot axis A4 of the tensioning arm through the bearing centre C of the tensioning roller bearing 16. When the tensioning roller 5 is not pivoted, the axis of rotation (A5) and the carrier axis A12 coincide. In the pivoted state, the rotary axis and the carrier axis A12 define a pivot plane Ea. In the axial view shown, the pivot plane Ea can lie within an angular range 13 of up to ±180° around the carrier axis A12 relative to a tangent plane T. In particular, the tangent plane T is a plane perpendicular to the radius R, which extends from the pivot axis A4 to the bearing center C. In an example, the axis of rotation A5 in the axial view shown can be pivoted at least within an angular range 13 of up to ±30° relative to the tangent plane T. For example, the exact adjustment of the axis of rotation A5 can be oriented, depending on the specific design and installation situation, to the belt 34 wrapped around the tensioning roller 5. The pivot plane Ea can be located at least approximately in the bisecting plane between the two belt portions adjacent to the tensioning roller. FIG. 6 shows an example of two possible positions of the pivot plane with Ea and Ea′, whereby any other angular position (β) is possible.

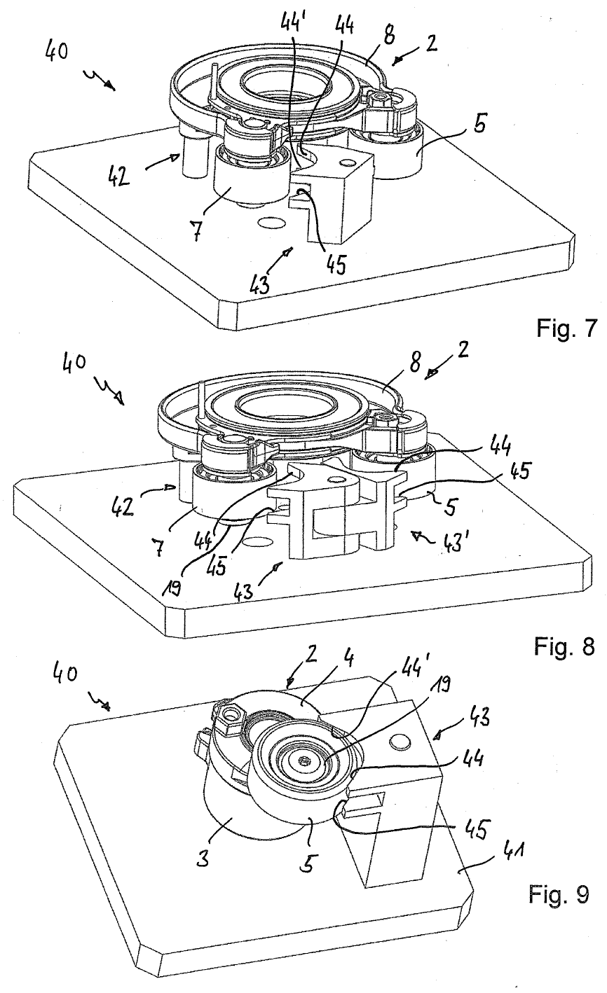

FIG. 7 shows an adjusting device 40 for adjusting the tensioning arrangement according to any one of FIGS. 1 to 4. The adjusting device is used to adjust the pivot angle for a tensioning arrangement 2 in which only one tensioning roller is adjustable by means of a corresponding adjusting mechanism 11.

The adjusting device 40 comprises a base plate 41, a holding device 42 for fixing the tensioning arrangement 2 to the base plate 41, and an alignment element 43 which is connected to the base plate 41 and has a plurality of alignment faces 44, 45 against which the tensioning roller 7 can be brought into contact in a tensioned state of the belt tensioner 2.

The device 40 enables the tensioning roller 7 to be easily adjusted to the desired position relative to the carrier element 12 and the base member 3 of the tensioning arrangement 2 respectively and to be fixed in this position. The alignment element 43 of the adjusting device 40 is initially set in the position required for the desired pivot position of the tensioning roller 7 or is provided in the desired configuration. By placing the tensioning arrangement 2 on the holding device 42 and applying the tensioning roller 7 against the alignment faces 44, 45 under spring pretension, the tensioning roller 7 is pivoted into the desired position. The arrangement is fixed in this position by subsequently tensioning the tensioning roller 7 on the carrier element 12 by means of the tensioning element 19.

The alignment element 43 has at least two alignment faces 44, 44′ which are offset to each other in the circumferential direction of the tensioning roller 7. In this way a secure support is achieved in a plane perpendicular to the axis of rotation A5. Furthermore, the alignment element 43 has at least two alignment faces 44, 45′ which are offset to each other in the axial direction of the tensioning roller 7. In this way a secure support in a plane parallel to the axis of rotation A5 is achieved.

FIG. 8 shows an adjusting device 40 for adjusting a tensioning arrangement 2 according to any one of FIGS. 1 to 4, in a second embodiment. The adjusting device 40 serves to adjust the pivot angle α for a tensioning arrangement 2, in which one or two tensioning rollers 5, 7 are adjustable by means of a corresponding adjusting mechanism 11. The present adjusting device 40 largely corresponds to the embodiment shown in FIG. 7, the description of which is referred to in abbreviated form for common features. The same or modified details are marked with the same reference signs as in FIG. 7.

A special feature of the present embodiment according to FIG. 8 is that it has two alignment elements 43, 43′, which can be pivoted against each other about a pivot axis. The alignment elements 43, 43′ of the setting device 40 can be set individually or jointly in the position required for the desired pivot position of the tensioning rollers 5, 7 or a suitable configuration can be provided for this purpose. By placing the tensioning arrangement 2 on the holding device 42 and applying the tensioning rollers 5, 7 against the alignment faces 44, 45 under spring pre-tension, the tensioning rollers 5, 7 are pivoted into the required positions. The arrangement is fixed in the desired pivot positions by subsequently tensioning the tensioning rollers 5, 7 on the respective carrier element 12, 13 by means of the tensioning element 19 or nut, respectively.

FIG. 9 shows an adjusting device for adjusting a tensioning arrangement 2 according to FIG. 5, which has only one tensioning arm 4. The design and operation of the present adjusting device 40 as shown in FIG. 9 largely corresponds to the embodiment shown in FIG. 7, the description of which is referred to in abbreviated form. The same or modified details are marked with the same reference signs as in FIG. 7. In accordance with the design of the single-arm tensioner as shown in FIG. 5, the alignment element 43 of the adjusting device 40 as shown in FIG. 9 is correspondingly larger, so that the tensioning roller 5 can be brought into contact with the alignment faces 44, 45 of the alignment element 43 and brought into the desired pivot position.

An advantage of the tensioning arrangements 2 and the adjusting devices 40 is that the bearings 16 of the tensioning rollers 5, 7 and accordingly the respective tensioning roller can be adjusted to a desired position relative to the carrier element 12, 13. A defined misalignment of the tensioning roller 5, 7 relative to the carrier 12, 13 and base member 3 respectively can be achieved in a simple and cost-effective manner, which can also be zero.

### LIST OF REFERENCE SIGNS

2 tensioning arrangement
3 base member
4 first tensioning arm
5 first tensioning roller
6 second tensioning arm
7 second tensioning roller
8 spring
9 spring support
10 spring support
11 adjustment mechanism
12 carrier portion
13 carrier portion
14 bearing portion
15 bearing portion
16 bearing
17 bearing receptacle
18 supporting element
19 clamping element
20 inner bearing ring
21 bore
22 clamping nut
23 face
24 face
25 face
26 face
27 head portion
28 engagement contour
29 inner thread
30 cylinder portion
31 head portion
32 belt drive
33 auxiliary unit
34 belt
35 belt pulley
36 belt pulley
37 belt pulley
38 belt
40 adjusting device
41 base plate
42 holding device
43, 43′ alignment element
44, 44′ alignment face
45 alignment face
46 mounting element
47 opening
α angle
β angle
A axis
C bearing center
L length
M pivot centre
P position
R radius

1.-15. (canceled)

16. An apparatus for a traction drive, comprising:
a base member;
at least one tensioning arm that is pivotably supported relative to the base member about a pivot axis;
a tensioning roller that is connected to a carrier element of the at least one tensioning arm by a bearing so as to be rotatable about an axis of rotation; and
an adjusting mechanism configured to pivot the bearing relative to the carrier element in a pivot range and to fasten the bearing in a pivot position within the pivot range.

17. The apparatus of claim 16,
wherein the bearing is pivotable relative to the carrier element about an axis of the carrier element in a pivot range of up to ±1°.

18. The apparatus of claim 16,
wherein the adjusting mechanism has a bearing receptacle in which the bearing is received, a supporting element against which the bearing receptacle is axially supported, and a clamping element for clamping the bearing receptacle against the supporting element, wherein the bearing receptacle is pivotable relative to the supporting element in an unclamped state of the clamping element and is fixable relative to the supporting element by clamping the clamping element.

19. The apparatus of claim 18,
wherein the bearing receptacle has a contact face which is in contact with a supporting face of the supporting element, wherein at least one of the contact face and the supporting face is spherical.

20. The apparatus of claim 18,
wherein the bearing receptacle has a pressure face which is in contact with a clamping face of the clamping element, wherein at least one of the pressure face and the clamping face is spherical.

21. The apparatus of claim 16,
wherein the bearing is pivotable relative to the carrier element about a pivot point which is arranged within an axial extension of the bearing.

22. The apparatus of claim 19,
wherein a radius of at least one of the contact face and the supporting face is smaller than a largest outer radius of the tensioning roller.

23. The apparatus of claim 16,
wherein the bearing is pivotable relative to the carrier element about a pivot point which is arranged outside an axial extension of the bearing.

24. The apparatus of claim 23,
wherein a bearing receptacle has a contact face which is in contact with a supporting face of a supporting element, wherein at least one of the contact face and the supporting face is spherical, wherein a radius of the at least one of the contact face and the supporting face is larger than a largest outer radius of the bearing.

25. The apparatus of claim 16,
wherein a bearing receptacle has a two piece design with a first bearing receiving part that receives the bearing at a first axial end, and a second bearing receiving part that receives the bearing at a second axial end, wherein the first bearing receiving part and the second bearing receiving part are axially clampable against one another by means of a clamping element.

26. The apparatus of claim 16,
wherein a bearing receptacle has a central bore through which a clamping element extends, the clamping element having radial play relative to a bore wall.

27. The apparatus of claim 16,
wherein a clamping element has a head portion forming a clamping face and a cylinder portion extending into a bearing receptacle.

28. The apparatus of claim 16,
wherein one of a clamping element and a counter element is designed in the form of a screw with an outer thread, and the other one of the clamping element and the counter element is designed in the form of a nut with a matching inner thread.

29. A device for adjusting an apparatus comprising a base member, at least one tensioning arm that is pivotably supported relative to the base member about a pivot axis, a tensioning roller that is connected to a carrier element of the at least one tensioning arm by a bearing so as to be rotatable about an axis of rotation, and an adjusting mechanism configured to pivot the bearing relative to the carrier element in a pivot range and to fasten the bearing in a pivot position within the pivot range, the device comprising:
a base plate;
a holding device for fixing the apparatus to the base plate; and
an alignment element which is connected to the base plate and has at least one alignment face against which the tensioning roller can be brought into contact in a tensioned state of the apparatus.

30. The device according to claim 29,
wherein the alignment element has at least two alignment faces which are arranged offset with respect to one another in the circumferential direction of the tensioning roller.

31. The device according to claim 29,
wherein the alignment element has at least two alignment faces which are arranged offset with respect to one another in the axial direction of the tensioning roller.
